(19) United States
(12) Patent Application Publication
(10) Pub. No.: US 2026/0310757 A1
(43) Pub. Date: Oct. 8, 2026

(54) Predict Near Term Major Earthquakes and Generate Evidence-Based Credible Pre-Warnings

(71) Applicant: Sheree H Wen, Medina, WA (US)

(72) Inventor: Sheree H Wen, Medina, WA (US)

(21) Appl. No.: 19/171,220

(22) Filed: Apr. 5, 2025

(51) Int. Cl. G06N 20/00; G06F 18/25

(52) U.S. Cl. CPC G06F 18/256; G01V 1/01

(57) ABSTRACT

A novel system and method for near-term earthquake prediction is disclosed, weaving multiple independent datasets, including historical and real-time satellite-based remote sensing data and terrestrial seismic testing data. The system employs artificial intelligence and machine learning to analyze correlations, detect precursor signals, and generate probabilistic forecasts. The predictive model continuously evolves using newly acquired data, improving accuracy and reliability. The invention aims to provide an effective early warning system for mitigating earthquake-related risks. This system and its methods can monitor and predict mega earthquake precursors at the earliest time, days and hours ahead to allow proper evacuation and infrastructure preparations.

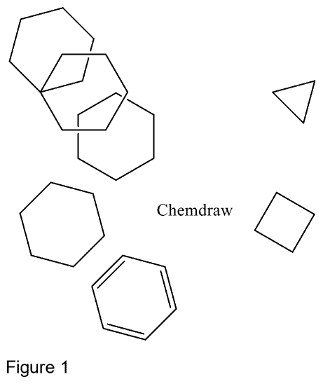

### BACKGROUND OF THE INVENTION

### Background

Earthquake prediction remains a significant challenge due to the complexity and dynamic nature of seismic activities. Traditional seismology primarily relies on ground-based sensor networks to detect and analyze precursory signals. However, advancements in remote sensing technologies have introduced the potential for utilizing satellite data, ionospheric disturbances, thermal anomalies, and other geophysical parameters to improve prediction models. The absence of a comprehensive system that integrates multiple independent datasets in real time limits the accuracy and reliability of earthquake forecasting. The ability to predict major earthquakes hours or days in advance would save thousands of lives, protect infrastructure, and mitigate adverse impacts on human health and well-being.

### Field of the Invention

This invention pertains to earthquake prediction methodologies and systems, specifically integrating independent historical and real-time satellite and terrestrial data sources to enhance the accuracy of short-term earthquake forecasting. The system generates evidence-based credible precursor warnings at the earliest possible time.

### SUMMARY OF THE INVENTION

Summary: This invention provides a novel method and system for predicting near-term major earthquakes by weaving multiple independent datasets, including and not limit to historical and real-time satellite data, ground-based seismic monitoring, ionospheric ion concentration changes, thermal infrared anomalies, and other geophysical indicators. The system employs a customized, paired machine learning and Al framework to analyze correlations among time-based parameters and identify patterns indicative of imminent seismic activity at specific locations.

### BRIEF DESCRIPTION OF DRAWINGS

### Drawings for Evidence Based Earthquake Prediction and Warning Systems

### 1. Data Acquisition Modules:

Collects historical and real-time datasets along a timeline from independent sources, including and not limited to: Satellite-based remote sensing data; Ground-based seismic sensors, geological testing stations, earth shift, atmospheric and environmental data, and other indicators that are linked to earthquake precursors. Each Technology Data set is in pairs-Historical and Life stream are managed by a pair of AI agents throughout the Weaving and prediction Process.

### 2. Data Weaving Engine:

Utilizes artificial intelligence (AI), deep machine learning algorithms, and other relevant techniques to auto-correlate independent datasets, identify patterns, and generate predictive models.

### 3. Prediction Algorithm:

Apply statistical, Artificial Intelligence, AI agents, deep learning, distillation, quantization, and other methods to assess the probability of a major earthquake occurring within a near-term timeframe.

### 4. Worldwide Mega-Earthquake Historic Database Model:

Continuously taking input and storing historic Mega-earthquake data stream for future weaving processing. Real-time refreshing labeled Maga-earthquake data stream, AI agent, and related process parameters.

### 5. Pre-warning Alert System:

Issues automated notifications to relevant authorities and the public based on threshold-based risk assessments.

### 6. Validation and Continuous Learning:

Continuously updates prediction models with newly acquired data and post-event analyses to improve accuracy over time.

### DETAILED DESCRIPTION OF THE INVENTION

Detailed Description: The proposed system consists of the following components:

### 7. Data Acquisition Module:

Collects historical and real-time datasets along a timeline from independent sources, including and not limited to:
a. Satellite-based remote sensing data (e.g., thermal infrared imaging, ionospheric changes, GPS-based crustal movements, GNSS total electron content, SAR/INSAR surface topography changes, strain rate, direction and geomagnetic variations.
b. Ground-based seismic sensors, geological testing stations, earth shift, new earth surface breakage, Strain, earth magnetic changes, water level changes, and other indicators.
c. Atmospheric and environmental data linked to earthquake precursors.

### 8. Data Weaving Engine:

Utilizes artificial intelligence (AI), deep machine learning algorithms, and other relevant techniques to auto-correlate independent datasets, identify patterns, and generate predictive models.

### 9. Prediction Algorithm:

Apply statistical, Artificial Intelligence, AI agents, deep learning, distillation, quantization, and other methods to assess the probability of a major earthquake occurring within a near-term timeframe.

### 10. Worldwide Mega-Earthquake Historic Database Model:

Continuously taking input and storing historic Mega-earthquake data stream for future weaving processing. Real-time refreshing labeled Maga-earthquake data stream, Al agent, and related process parameters.

### 11. Pre-Warning Alert System:

Issues automated notifications to relevant authorities and the public based on threshold-based risk assessments.

### 12. Validation and Continuous Learning:

Continuously updates prediction models with newly acquired data and post-event analyses to improve accuracy over time.

1-4. (canceled)

5: A system for predicting near-term major earthquakes and managing automated responses, the system comprising:
a central server configured to intake data from satellite, near-earth, and ground sources, and comprising a historical mega-earthquake database and artificial intelligence (AI) engines;
a data acquisition module configured to collect a plurality of independent time-based geophysical datasets, including satellite-based SAR and InSAR topography data, near-earth ionospheric data, and ground-based seismic data;
a historical database, being either global or regional, configured to store labeled mega-earthquake data streams and identified precursor signatures;
an edge server communicatively coupled to the central server and localized at a station, the edge server comprising:
a) a system input module configured to intake data streams, time-stamped images, and strain maps with earth coordinates, and to form AI agent pairs;
b) a data weaving engine utilizing artificial intelligence to correlate real-time geophysical data with said historical signatures to identify imminent seismic patterns;
c) a prediction engine configured to assess the probability, magnitude, predicted time, and location of an upcoming earthquake event;
a command control center located at a local station to oversee system processes, the command control center comprising:
a) an alert system configured to provide real-time warnings to authorities and the public; and
b) a command control module programmed to automatically instigate emergency response actions upon the detection of a significant risk factor.

6: The system of claim 5, further comprising a decentralized network of local monitoring edge servers configured to weave and predict from locally collected data with the historical database.

7: The system of claim 5, wherein the command control module is configured to trigger automated evacuation and rescue actions and is further configured to act autonomously with or without human intervention.

8: The system of claim 5, wherein the data acquisition module is further configured to generate crustal strain maps and process ion concentration fluctuations as seismic precursors.
